(19) United States
(12) Patent Application Publication
(10) Pub. No.: US 2026/0246028 A1
(43) Pub. Date: Aug. 20, 2026

(54) TEMPERATURE CONTROL SYSTEM FOR AN ELECTRIC VEHICLE

(71) Applicant: Ford Global Technologies, LLC, Dearborn, MI (US)

(72) Inventors: Hans Guenter Quix, Herzogenrath (DE); Guenter Hans Grosch, Vettweiß (DE)

(21) Appl. No.: 19/453,787

(22) Filed: Jan. 20, 2026

(30) Foreign Application Priority Data
Feb. 20, 2025 (DE) 102025106560.8

(51) Int. Cl. H01M 10/663; B60H 1/00; B60H 1/14; B60K 11/04; H01M 10/625; H01M 10/6551; H01M 10/6563

(52) U.S. Cl. CPC H01M 10/663; B60H 1/00278; B60H 1/00392; B60H 1/143; B60K 11/04; H01M 10/625; H01M 10/6551; H01M 10/6563; B60H 2001/00307; H01M 2220/20

(57) ABSTRACT

A temperature control system for an electric vehicle includes an exchange arrangement with a radiator for dispensing operating heat, a primary heat exchanger arranged with respect to a longitudinal axis in front of the radiator, and a fan unit, which is designed to generate an air flow from an inlet side to an outlet side of the exchanger assembly opposite the longitudinal axis. An air passage arrangement is arranged on the outlet side of the exchanger arrangement, which can be at least partially locked in a locking position and released in a release position by a motorised locking unit with at least one blocking element. At least one guide wall is spaced perpendicular to the longitudinal axis of the exchanger assembly and limits a return channel extending next to the exchanger assembly. A return current from the outlet side to the inlet side can be returned through the return channel.

### CROSS-REFERENCE TO RELATED APPLICATIONS

This disclosure claims priority to German Patent Application No. 102025106560.8, which was filed on February 20, 2025, and is incorporated herein by reference in its entirety.

### TECHNICAL FIELD

This disclosure relates to a temperature control system for an electric vehicle.

### BACKGROUND

In motor vehicles with an internal combustion engine, the waste heat of the engine can be used to heat the vehicle interior if necessary, but this is not possible in electric vehicles, or at least not in the same way. This applies in particular to battery-powered electric vehicles. Heating the interior by means of an electric PTC heater would in principle be possible, but it would be potentially inefficient in terms of energy. This is why such electric vehicles often use a heat pump system to generate heat. A significant proportion of the heat required for heating is generally taken from the environment of the vehicle. This significantly increases efficiency compared to a PTC heater. However, the efficiency in cold ambient conditions, e.g., below -10°C, decreases significantly. The surrounding heat exchanger can also ice up.

DE 10 2011 013 856 B4 shows a device having a heat exchanger module, which can be connected to the environment via an adjustable cooling air blind in a supply air duct and is composed of a condenser or gas cooler of the air conditioning system, a water cooler and at least one downstream, electrically driven fan and connects it to an engine compartment of a motor vehicle drive source cooled by the water cooler. The air conditioning system can be switched over as an air heat pump and in this operating state, in particular, the cooling air venetian is closed and the heated air from the engine compartment is conveyed back and forth via the activated fan in recirculation mode through the heat exchangers. In the engine compartment, at least one of the heat exchanger module bypassing, in the supply air duct leading air supply line is provided, which can be controlled via at least one shut-off device, wherein the shut-off device is opened when the cooling air blind is closed and the fan is activated.

From EP 3 609 725 B1, a method is known for de-icing an external air-side heat exchanger of a motor vehicle air conditioning system with heat pump, with which both a cooling function and a heating function for the vehicle interior can be provided as required, in which, during a heating operation, a temporary switch is made to a cooling operation when detecting or estimating a predetermined degree of icing of the external air heat exchanger in order to cause a complete or partial defrosting of the ice on the external air heat exchanger. In order to maintain the vehicle interior heating during the de-icing process, the temperature of the air flowing into the external air heat exchanger is increased. Increasing the temperature of the air flowing into the external air heat exchanger is achieved by simultaneously closing a radiator grille shutter during the de-icing process and operating a fan associated with this heat exchanger and arranged downstream of the radiator grille shutter.

JP 2006 / 341 784 A discloses a system comprising at least one compressor for compressing and heating a refrigerant, an external heat exchanger for the exchange of heat between the refrigerant and the introduced air, an evaporator for the exchange of heat between the supply air and the refrigerant, an internal heat exchanger for the exchange of heat between the refrigerant cooled in the outer heat exchanger and a low-pressure refrigerant returning to the compressor, and a heat exchanger for the exchange of heat between the refrigerant cooled in the outer heat exchanger and a low-pressure refrigerant returning to the compressor. A cooler located parallel to the outer heat exchanger is set up for heat exchange between cooling water and supplied air and a cooling fan for introducing air into the outer heat exchanger and the cooler. A control unit is designed to set a coolant flow rate according to a set temperature and a coolant path according to an operating mode, the controller rotating the cooling fan forward in a cooling mode to introduce air from the outer heat exchanger towards the radiator, and the cooling fan reverse in a cooling mode.

Exemplary embodiments of this disclosure make it possible to efficiently control the temperature of components of an electric vehicle.

### SUMMARY

According to the embodiments of this disclosure, the object is achieved by a cooling system having the features of claim 1, wherein the dependent claims relate to advantageous embodiments of the present disclosure.

According to an embodiment, the air passage arrangement is arranged with respect to the longitudinal axis behind the exchanger arrangement. Accordingly, the air flow passes first through the primary heat exchanger and then through the radiator. It can absorb considerable heat at the radiator before it is completely or partially deflected and returned to the inlet side as a reverse current against the longitudinal axis. As already described, at least part of the return flow flows into the air flow again, which now flows into the primary heat exchanger. The previously absorbed heat can be partially discharged to the primary heat exchanger and the fluid contained in it. The air passage arrangement and/or the at least one guide wall between the exchanger arrangement and a front chamber, which can also be referred to as the engine compartment of the electric vehicle, are interposed. Both the exchanger assembly and a drive motor of the electric vehicle can be arranged in a front portion of the electric vehicle, whereby the exchanger assembly is arranged adjacent to the engine compartment. If the engine compartment is not isolated from the vehicle environment, comparatively cool ambient air could enter the air flow through the engine compartment, which will make the heat transfer to the primary heat exchanger worse. However, if the air passage arrangement (including the blocking unit) and/or at least one baffle partially shield the exchanger arrangement from the engine compartment, the penetration of ambient air via the engine compartment is minimised.

Another embodiment provides that the air passage arrangement is arranged with respect to the longitudinal axis in front of the exchanger arrangement. Accordingly, the air flow runs against the longitudinal axis first through the radiator and then through the primary heat exchanger. It absorbs heat at the radiator before it flows into the primary heat exchanger. It is then completely or partially deflected and returned to the inlet side as a return current in the direction of the longitudinal axis. At least part of the return flow flows into the air flow, which can then absorb heat from the radiator again. This configuration normally provides that the fan unit can be operated in two opposite directions. At higher temperatures, it can generate an air flow in the direction of the longitudinal axis, which can be generated partially or completely by the driving movement of the electric vehicle. The locking unit can be in the release position. At lower temperatures, the fan unit can be operated in the opposite direction to produce an air flow in the opposite direction to the longitudinal axis. The locking unit is adjusted accordingly to the locked position, resulting in the air circulation described above.

The blocking unit may be adjustable or adjusted according to at least one intermediate position in which a degree of release of the air passage arrangement lies between the blocking position and the release position. The setting of at least one blocking element is in the intermediate position can be between that in the locked position and that in the enable position. In any case, the air passage assembly is locked in the intermediate position to a lesser extent than in the locked position, but to a greater extent than in the release position. This generally results in part of the air flow being returned to the inlet side as a (less powerful) return flow, while another part passes through the air passage arrangement and is discharged from the outlet side. In total, a plurality of support elements may be provided. The intermediate position allows heat transfer from the radiator to the primary heat exchanger to be reduced compared to the locked position without reducing it to zero. An alternative way to do this would be to change the operating speed of the fan unit. This would have the disadvantage, however, that at the same time the release of the operating heat by the radiator would be significantly influenced.

The effect of a blocking element does not have to be limited to the optional release or blocking of a passage opening. It can also help to control the airflow. According to a corresponding embodiment, at least one blocking element is designed to deflect a part of the air flow in the blocking position and / or in at least one intermediate position through an obliquely aligned to the air flow in the direction of the nearest return channel. The corresponding surface, which is a surface of the blocking element, is aligned obliquely to the air flow and in particular obliquely to the longitudinal axis. If a part of the air flow flows through it, it experiences a force transversely to the longitudinal axis. The surface is aligned in such a way that the deflection takes place in the direction of the nearest return channel. If one and the same return channel is arranged on different sides, the deflection can take place more precisely in the direction of the nearest part of the return channel. In this way, turbulence can be reduced and/or the flow path to be travelled by the air can be minimised.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

Further advantageous details and effects are explained in more detail below on the basis of exemplary embodiments illustrated in the figures, In the figures:

FIG. 1 shows a schematic illustration of an exemplary embodiment of a vehicle,

FIG. 2 shows a schematic illustration of an exemplary embodiment of a temperature control system from the vehicle of FIG. 1,

FIG. 3 shows a sectional view of a part of the temperature control system from FIG. 2 with a blocking unit in a locked position;

FIG. 4 shows a rear view according to the direction IV in FIG. 3;

FIG. 5 shows a FIG. 3 corresponding sectional representation with the blocking unit in a release position;

FIG. 6 shows a section representation corresponding to FIG. 3 with the blocking unit in an intermediate position;

FIG. 7 shows a section of a part of a temperature control system according to a second embodiment, corresponding to FIG. 3;

FIG. 8 shows a section representation corresponding to FIG. 7 with the blocking unit in an intermediate position;

FIG. 9 shows a section representation corresponding to FIG. 7 with the blocking unit in an intermediate position;

FIG. 10 shows a section of a part of a temperature control system according to a third embodiment, corresponding to FIG. 3;

FIG. 11 shows a section of a part of a temperature control system according to a fourth embodiment, corresponding to FIG. 3;

FIG. 12 shows a section representation corresponding to FIG. 11 with the blocking unit in an intermediate position;

FIG. 13 shows the section representation of FIG. 12 with the blocking unit in an blocking position; and

FIG. 14 shows a diagrammatic depiction of a fifth embodiment of a gear unit.

FIG. 15 shows a sectional view of a part of the temperature control system from FIG. 14 with a blocking unit in a release position; and

FIG. 16 shows a FIG. 15 corresponding sectional representation with the locking unit in a locked position.

In the different figures, identical parts are always provided with the same reference signs, for which reason these parts are generally also described only once. The terms “first”, “second” etc. which are used in this application serve only for the purpose of differentiation. In particular, their use is not intended to imply any sequence or priority of the objects specified in conjunction with these terms.

### DETAILED DESCRIPTION

It should be noted that the features and measures specified individually in the following description can be combined with one another in any desired technically meaningful way and disclose further exemplary embodiments. The description additionally characterizes and specifies embodiments of this disclosure, in particular in conjunction with the figures.

Exemplary embodiments provide a cooling system for an electric vehicle. The cooling system is normally provided for motor vehicles such as heavy goods vehicles or passenger cars, but could conceivably also be used for rail vehicles or watercraft. Here, the term "electric vehicle" generally denotes a vehicle that has at least one electric motor that serves for driving the vehicle. In particular, the vehicle may be a purely electrically operated vehicle, but this does not rule out use in hybrid vehicles. The term "cooling system" generally means that at least some components of the cooling system are at least intermittently used for cooling components of the electric vehicle. "Tempering" in this context means the targeted influence of a temperature, in particular in order to keep this temperature within a specified range or to bring it into such a range. Components that at least do not directly serve the temperature control can also be considered as part of the temperature control system. This relates inter alia to components which are cooled, and to components which control the actual cooling components or assist these in terms of their function.

The temperature control system has an interchangeable arrangement. This has at least two heat exchangers, namely a radiator for dispensing operating heat, and a primary heat exchanger arranged with respect to a longitudinal axis in front of the radiator. The heat exchangers mentioned, however, can belong to different fluid circuits. The radiator is considered to be part of the tempering system, but it could also be considered an external element in this regard. It may in particular belong to a fluid circuit by means of which a drive motor and/or a transmission of the electric vehicle are cooled. Depending on the operating state of the electric vehicle, significant amounts of heat can therefore be emitted via the radiator. The heat emitted is released by the operation of the electric vehicle, which is why it is referred to here as operating heat. The radiator may be designed in particular as an air/liquid heat exchanger. During operation, the corresponding radiator receives cooling liquid, or is passed through by a flow of said cooling liquid, whilst being in contact at the other side with the ambient air. The radiator is typically installed at the front of the vehicle, where it can be optimally impinged on by the relative wind.

The primary heat exchanger is positioned in front of the radiator with respect to a longitudinal axis. Although the term "longitudinal axis" is used only to define a reference system, it may be the longitudinal axis of the vehicle (X axis), which faces the rear in the opposite direction of travel. Thus, a travel-related airflow, which is generated during forward travel relative to the electric vehicle, can flow through the primary heat exchanger first and then the radiator. With respect to the transverse axis (Y-axis) and vertical axis (Z-axis), the positions of the radiator and the primary heat exchanger may can overlap. As will be explained below, the primary heat exchanger may in particular be part of a fluid circuit, which can be used according to the principle of a heat pump for heating a vehicle interior or another vehicle component. The term "primary heat exchanger" serves only to distinguish between concepts and is in no way to be interpreted restrictively with regard to the design or arrangement of this heat exchanger. Nor does the designation imply, for example, that a secondary heat exchanger must be available.

Furthermore, the exchanger assembly has a fan unit which is designed to generate an air flow extending from an inlet side to a with respect to the longitudinal axis opposite outlet side of the exchanger assembly. The fan unit may have one or more motorised or driven fans. In some embodiments, it can also be referred to as a fan. In this example, it is electrically driven or driven and has its own electric motor. The fan unit can generate an air flow during operation, which passes through the exchanger arrangement, in particular also through the primary heat exchanger and the radiator. The side of the exchanger assembly from which the air flow is emitted is referred to here as the inlet side, while the side to which the air flow leads is referred to as the outlet side. This means that the inlet and outlet sides are defined by the operation of the fan unit. In some embodiments, the fan unit can optionally be operated in one of two opposite directions, wherein it can be said either that the inlet side and outlet side depend on the respective operating direction, or that in one of the operating directions, the air flow from the outlet side to the inlet side runs. In any case, the inlet side and the outlet side are opposite each other with respect to the longitudinal axis. However, the air flow does not have to be parallel or antiparallel to the longitudinal axis. In some situations, the airflow can also be generated in whole or in part by the forward movement of the electric vehicle. However, the fan unit is designed to generate the air flow alone, for example when the truck is at a standstill.

Furthermore, the temperature control system has an outlet side of the exchange arrangement arranged air passage arrangement, which can be locked or locked at least partially in a blocking position by a motorised adjustable or to be adjusted blocking unit with at least one blocking element and is released or released in a release position. The air passage assembly is located on the outlet side of the exchanger assembly and thus on the side on which the air flow generated by the fan unit exits from the exchanger assembly. The air passage arrangement has at least one passage opening, through which at least a part of the air flow can pass. In particular, a plurality of through openings may be formed. The air passage arrangement can, for example, comprise a grid or a grille within which the plurality of through openings are formed. In some embodiments, the air passage arrangement may be referred to as the radiator grille. The air passage arrangement is at least partially lockable or locked by a blocking unit. This means that air passage through the air passage arrangement can be prevented completely or at least partially by the blocking unit. The locking unit shall be adjustable or adjusted at least between a locking position and a release position. In the locked position, the air passage assembly is at least partially locked, while it is released in the release position. Thus, a level of release of the air passage arrangement is minimum in the blocked position (if necessary equal to zero) and maximum in the released position. The blocking unit has at least one blocking element, that can be a plurality of blocking elements. In each case, a blocking element can be precisely assigned to a through opening and designed to close this. However, embodiments are also conceivable in which a blocking element closes a plurality of through openings and / or a through opening is closed by a plurality of blocking elements. The locking unit, and thus the at least one locking element, can be motorised or adjusted. Each locking element may be movably connected to a frame of the air passage assembly. In particular, it can be swivelled. For example, it can be designed as a flap or lamella. When the locking unit is in the release position, the airflow can pass through the air passage assembly with minimal resistance. However, if the blocking unit is in the locked position, it forms a barrier to the airflow, which stops and/or diverts it.

Furthermore, the temperature control system has at least one transverse to the longitudinal axis of the exchange arrangement spaced guide wall, which limits a return channel extending next to the exchange arrangement. In an example, the guide wall is connected to the air passage arrangement. This means that it can be connected to the air passage arrangement, e.g., to be directly connected to a frame of the same, or even to be formed in one piece with it. The guide wall is spaced perpendicular to the longitudinal axis from the exchange arrangement, i.e., in the direction of the transverse axis and/or in the direction of the vertical axis. In an example, the guide wall is designed in itself airtight, although smaller openings are not relevant. The baffle extends along the longitudinal axis, but generally does not run parallel to it. Their distance from the exchanger assembly provides a space between them, which forms a return channel next to the exchanger assembly. "Next" may refer to an offset position with respect to the vertical axis and/or the transverse axis. In particular, the return channel may be arranged transversely to the longitudinal axis adjacent to the exchange arrangement. The term "channel" must not be interpreted as meaning that it must be closed on all sides and clearly delimited. In particular with regard to the exchange arrangement, the return channel may be open in places. Instead of a return channel, one can also speak of a return path. The guide wall and thus the return channel can extend from the outlet side to the inlet side, or vice versa. In any case, a return current from the outlet side to the inlet side can be fed back through the return channel. The return flow is also an air flow, which however is opposite to the above-mentioned air flow with respect to the longitudinal axis. When the blocking unit is in the release position, the reverse current may not be present or can be weak. However, if the blocking unit is placed in the locked position, the airflow cannot pass through the air passage arrangement, or only to a limited extent. It therefore at least partially swerves transversely to the longitudinal axis until it hits the guide wall. The baffle, in turn, causes a further deflection, whereby part of the air flow is returned to the inlet side as a return flow next to the exchanger arrangement. There, it can flow back into the air flow in whole or in part. Overall, a circular air flow is formed, i.e. the air circulates.

As the air circulates, air that has passed through the radiator and absorbed operating heat is inevitably passed by the primary heat exchanger in the further course, where it can release heat. This means that even at low outside temperatures, the primary heat exchanger can be supplied with pre-heated air, which increases its effectiveness as part of a heat pump and in particular minimises icing. The heat absorbed by the primary heat exchanger can be used, in particular, to heat a vehicle interior. The radiator is further cooled by the air flow and can therefore be operated effectively.

In an example, the temperature control system has a compressor for generating a fluid flow, and a temperature control device for heat exchange between the fluid flow and at least one vehicle region, wherein the primary heat exchanger upstream with respect to the fluid flow via a first expansion valve is fluid connected to the temperature control device and downstream, bypassing the first expansion valve, fluid is connected to the temperature control device via the compressor. The compressor is motorised or driven and can be electrically driven or driven in particular. When activated, it generates a fluid flow within the temperature control system. Overall, the generated fluid flow is self-contained, i.e. it forms a fluid circuit. However, it is possible that it is divided into partial flows and that partial flows are combined. The fluid serves for the transport of heat within the abovementioned heat circuit. In an example, the temperature control system uses the operating principle of a heat pump. The fluid is usually partially liquid and partially gaseous in the operating state. The fluid can also be called a working fluid or a refrigerant. In addition to pumping the fluid, the compressor is also used to generate a pressure difference. The part of the temperature control system in which the compressor is located can be referred to as the compressor section. The terms "battery section", "electronics section" and other sections yet to be mentioned below refer to parts of a system which, during operation, receives and conducts a liquid coolant. Each "section" may also be referred to as a "branch" or the like, that is to say, for example, "battery branch". A section may be linear or may be the form of a closed loop. Likewise, it may be branched or non-branched. The temperature control device is fluid-conducting and is in the operating state of at least a part of the fluid flow through, possibly also of the entire fluid flow. On the other hand, the fluid flow is in at least indirect thermal contact with at least one vehicle region, so that a heat exchange between this vehicle region and the fluid flow can take place. Thus, the temperature control device has at least one heat exchanger and can be designed in particular as a heat exchanger. The vehicle sector is, of course, an area of the electric vehicle. It can also be referred to as a vehicle section or part. However, they may also be different wheels. In order to realise the at least indirect thermal contact, the temperature control device can be arranged in the vehicle area or adjacent to it. The part of the tempering system in which the tempering device is located can be called a tempering section.

The primary heat exchanger is fluid-connected to the temperature control device upstream via the first expansion valve. The terms "upstream" and "downstream" refer to the direction of the fluid flow provided in the operating state. In this case, this means that the fluid flows from the temperature control device through the first expansion valve to the primary heat exchanger. It is understood that the connection between the temperature control device and the first expansion valve as well as the connection between the latter and the primary heat exchanger can be given directly or indirectly, i.e. it can be in particular at least one fluid-carrying line intermediate. "Fluid compound" means here and below that the compound is such that fluid can be passed from one component to another. It can also be said that fluid-connected components are fluid-connected or fluid-guided. In the operating state, at least part of the fluid flow from the temperature control device passes via the expansion valve to the primary heat exchanger and further via the compressor back to the temperature control device. The latter is performed by bypassing the first expansion valve, i.e. it is not passed through on the way from the primary heat exchanger to the temperature control device. The expansion valve, together with the compressor, is used to build up a pressure difference, with the primary heat exchanger on a low-pressure side and the temperature control device on a high-pressure side. The primary heat exchanger can act as an evaporator, while the temperature control device acts as a condenser. Thus, heat can be dissipated to at least one vehicle area, i.e. this can be heated.

The temperature control device can be used for temperature control of different truck areas. In particular, it can be assigned to a vehicle interior. The vehicle interior can correspond to a passenger car, although it can additionally or alternatively also have a cargo space (e.g. trunk) of the electric vehicle. This means that the temperature control device is used to air-condition the corresponding interior. The corresponding heat exchanger, which can also be referred to as an interior heat exchanger, can be equipped with a (e.g. Electrically operated) fan unit. This ensures that air that has been heated or cooled on the heat exchanger is distributed more quickly inside the vehicle. Alternatively or additionally, the temperature control device can be assigned to a vehicle battery. In this case, the temperature control device can be designed for both cooling and heating the vehicle battery, in particular a traction battery. The term "battery" expressly includes battery packs that are strictly speaking composed of a plurality of individual batteries. A corresponding heat exchanger, which can be referred to as a battery heat exchanger, can either be in direct thermal contact with the respective vehicle battery, but in particular indirect thermal contact via a coolant is also possible.

The recirculation of air can be enhanced if a large cross-section is available for the return flow. This can be supported in an embodiment in that at least one return channel is formed on two transverse to the longitudinal axis opposite sides of the exchange arrangement, which is limited by at least one guide wall. The opposite sides can, for example, Be located above and below the exchanger assembly, or to the left and right of the exchanger assembly. In this case, two separate return channels can be formed on the opposite sides. However, it could also be a single return channel extending from one side to the other side all around the edge of the exchanger arrangement. Likewise, a separate guide wall can be assigned to each return channel, or it can be a single, self-contained guide wall. In any case, the part of the air flow held back by the blocking unit is divided and directed to the opposite sides, where it is directed to the inlet side through the opposite return channels or parts of a return channel.

Due to different considerations, e.g., however, for reasons of limited installation space, it can also be advantageous if, for example, a feedback channel is formed on only one side with respect to the transverse axis or the vertical axis. According to a corresponding embodiment, a barrier wall is connected to the exchanger arrangement on one side transversely to the longitudinal axis, which prevents a reverse current on this side. The barrier wall can be designed in a similar way to a guide wall and can also be directly connected to the air passage arrangement. However, the barrier wall is directly connected to the exchanger assembly, so that there is no space between it and the exchanger assembly for a return channel. Accordingly, no reverse current is possible on this page. On the other hand, this design allows space savings on the corresponding page.

In addition to or alternatively to the presence of such a barrier wall, one embodiment provides that the blocking unit is arranged transversely to the longitudinal axis at the height of a first partial region of the exchanger assembly, while a second partial region of the exchanger assembly is arranged transversely to the longitudinal axis offset therefor. This configuration leads to the fact that the part of the air flow, which flows through the first partial area, can be blocked by the blocking unit and can be deflected as described. The part of the air flow that passes through the second sub-area is essentially independent of the setting of the blocking unit and can be discharged to the outlet side even if the blocking unit is in the blocking position. Depending on the embodiment, the air passage arrangement may only be arranged at the height of the first partial region or it may extend to both partial regions. In the latter case, it is only partially lockable or locked by the blocking unit.

While the recirculation channel performs an important function for the formation of the described air circulation, it could have a counterproductive effect if no air circulation is desired. In particular, since the flow resistance of the return channel can be significantly smaller than the flow resistance of the exchanger arrangement, air via the return channel could bypass the exchanger arrangement. This would lead to a deteriorated heat exchange. The feedback channel is advantageous, if the blocking unit is in the release position, either partially or completely lockable or locked. This is achieved according to an embodiment in that the blocking unit has at least one blocking element, which in the release position minimises a connection between a return channel and a formed between the exchanger arrangement and the air passage arrangement outlet region and releases the connection in the locked position. The outlet region is formed on the outlet side of the exchanger assembly, between the exchanger assembly and the air passage assembly. When the blocking unit is closed, the air flow is completely or partially contained in this outlet region and then routed to the at least one return channel. However, if the blocking unit is in the release position, it should not be possible to exchange air via the return channel. This is achieved in the aforementioned configuration by one of the blocking element, which thus has a dual function. In the blocking position, it can lock a above-mentioned passage opening of the air passage arrangement, while in the release position, it minimises the connection between the return channel and the outlet region at least, advantageously also completely interrupts. Depending on the design, different sections of the blocking element for blocking a through opening on the one hand and for blocking the connection between the return channel and the outlet region on the other hand may be formed.

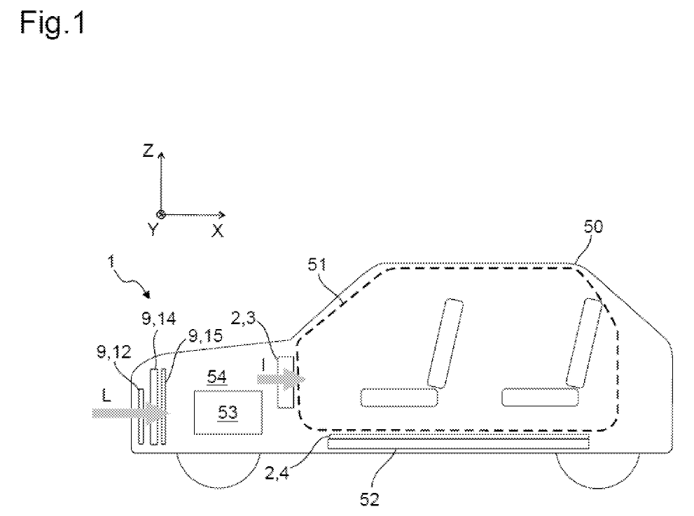

FIG. 1 shows a battery-powered electric vehicle (BEV) 50, in this case a passenger car, with parts of a temperature control system. Here and in the following figures, a longitudinal axis X, a transverse axis Y and a vertical axis Z of the electric vehicle 50 are drawn. Schematically illustrated is an interior space 51, which can also be referred to as a passenger cell. The schematic illustration shows a battery section having a battery 52 that serves as an energy source for various systems of the electric vehicle, in particular also for an electric drive motor 53. The drive motor 53 arranged in an engine compartment 54 is assigned to a cooling circuit, of which only a radiator 14 arranged in the front portion of the electric vehicle 50 is shown. Comparatively large amounts of heat must be discharged to an air flow L via this radiator 14.

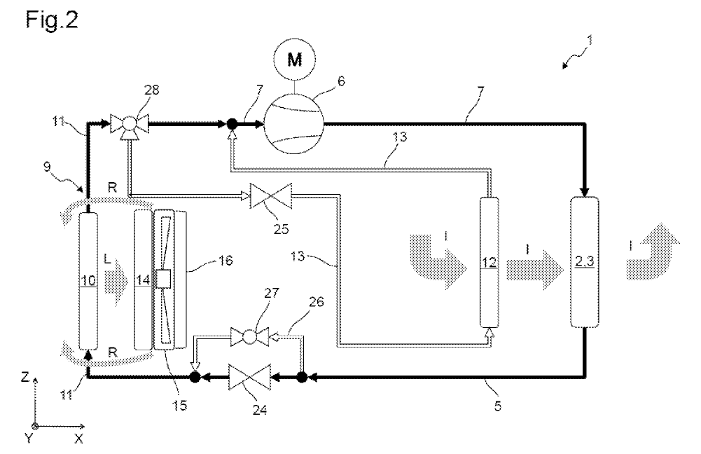

The temperature control system 1 is used for temperature control of vehicle areas, in this case for temperature control of the interior space 51 and the battery 52. The interior space 51 is assigned to an interior heat exchanger 3, while the battery 52 is assigned to a battery heat exchanger 4. Both said heat exchangers 3, 4 form parts of a temperature control device 2. The interior heat exchanger 3 is passed through by an interior air flow I, which then leads into and through interior space 51. Furthermore, the temperature control system 1 comprises a primary heat exchanger 10, a fan unit 15 and a secondary heat exchanger 12 (shown in FIG. 2). The primary heat exchanger 10 is arranged with respect to the longitudinal axis X in front of the radiator 14, while the fan unit 15 is arranged with respect to the longitudinal axis X behind the radiator 14.

FIG. 2 shows a schematic representation of a first embodiment of the tempering system 1. Only the interior heat exchanger 3 of the temperature control device 2 is shown. The temperature control device 2 is arranged in a temperature control section 5, which is part of a fluid-conducting system which receives a fluid, which can also be referred to as working fluid or refrigerant. By an electrically operated compressor 6 a fluid flow can be generated, the course of which is shown in FIG. 2 by arrow directions, wherein through-flowing lines in the drawings are filled and not through-flowing lines in the drawings are shown unfilled. Downstream, a primary heat exchanger section 11 is connected to the temperature control section 5, in which a first expansion valve 24 and the primary heat exchanger 10 are arranged. The first expansion valve 24 can be completely or partially bypassed by a bypass section 26 with a bypass valve 27. Downstream of the primary heat exchanger section 11, a two-way valve 28 is connected via which a connection to a compressor section 7 with the compressor 6 and on the other hand to a secondary heat exchanger section 13 can be made. In FIG. 2, the connection to the secondary heat exchanger section 13 is separated, which comprises a second expansion valve 25 and a secondary heat exchanger 12 or evaporator. The secondary heat exchanger 12 can be arranged in a fan housing. It can be used to cool and/or dehumidify the interior air flow I, which is blown into interior space 51, if necessary. The latter can also occur when the interior space 51 is heated by means of the interior space heat exchanger 3.

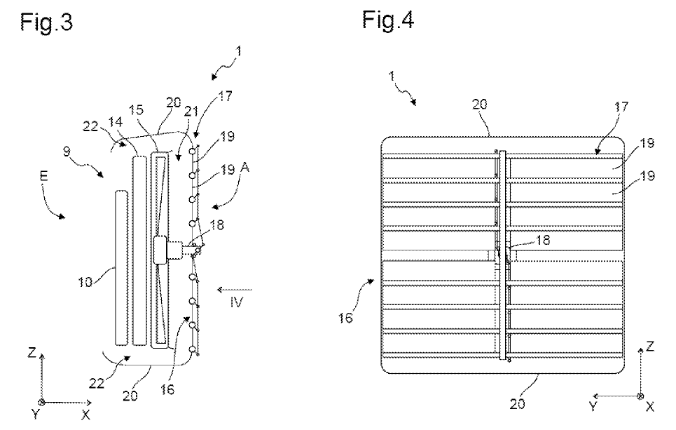

FIGS. 3 and 4 show a part of the tempering system 1. The primary heat exchanger 10, the radiator 14 and the fan unit 15 are recognizable as parts of an exchanger assembly 9. With reference to the air flow L, which can be generated by the fan unit 15 or is generated, an inlet side E and an outlet side A opposite to the longitudinal axis X are drawn. On the outlet side A, an open, for example grid-like air passage arrangement 16 is arranged, which has a plurality of through openings (without reference sign) for the air flow L. With respect to the vertical axis Z on both sides, two guide walls 20 are connected to the air passage arrangement 16, which extend opposite the longitudinal axis X to the front to the inlet side E. An outlet region 21 is formed between the exchanger assembly 9 and the air passage arrangement 16. Each of these is connected to a return channel 22, which extends between one of the guide walls 20 and the exchanger assembly 9. An air filter is arranged on the air passage arrangement 16. This has a plurality of lamellar-like blocking elements 19, which are pivotable or swiveled around parallel to the transverse axis Y. FIG. 3 and 4 show the blocking elements 19 in a closed state and the blocking unit 17 thus in a closed position. The blocking elements 19 can be motorized via an actuator 18.

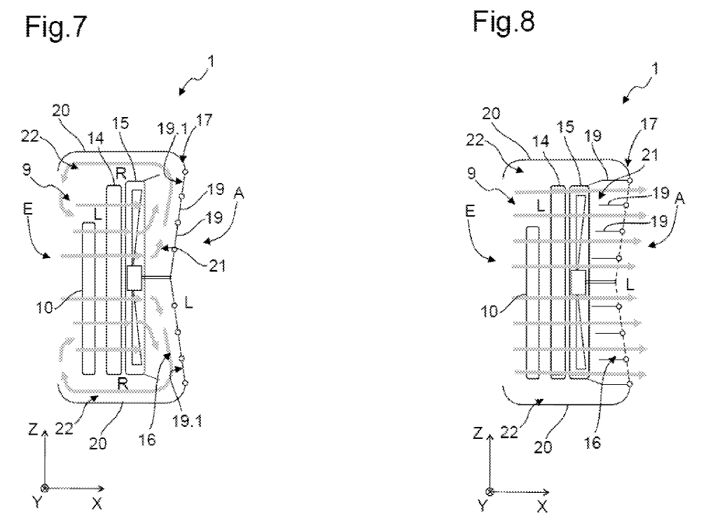

The closed position shown in FIG. 3 and 4 is provided for a situation in which heating of the interior space 51 and/or the battery 52 is required, although a low ambient temperature is present. If the fan unit 15 generates an air flow L extending from the input side E to the output side A through the exchanger arrangement 9, this receives heat as it passes through the radiator 14. In the outlet region 21, the air flow L is blocked by the blocking elements 19 and at least partially deflected upwards and downwards to the guide walls 20, from where it reaches the inlet side E again via the return channels 22 as a return flow R. There, the return flow R flows back into the air flow L. The air has absorbed heat as described when passing through the radiator 14, which is why the primary heat exchanger 10 is now supplied by a comparatively warm air flow L. Thereby, the primary heat exchanger 10 can effectively act as an evaporator in a circuit described in the above circuit, wherein the fluid absorbs heat and this acts as a capacitor interior heat exchanger 3 emits. In particular, even at low outside temperatures, it can be prevented that the primary heat exchanger 10 is icy. Since the air passage arrangement 16 with the blocking unit 17 and the guide walls 20 between the exchanger arrangement 9 and the engine compartment 54 are intermediate, any ambient air that has entered the engine compartment 54 can at most be mixed to a small extent in the air flow L. The air flow L and the return flow R are not shown in FIGS. 3, 5 and 6, but in FIGS. 7-9, which refer to a second embodiment very similar to the first embodiment.

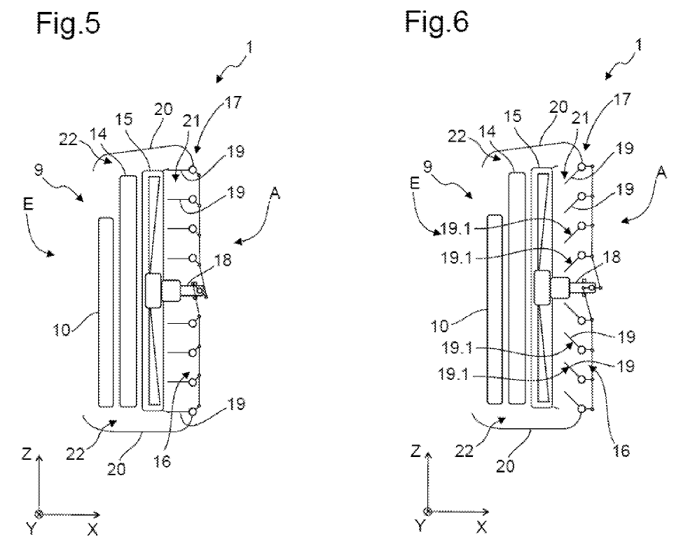

FIG. 5 shows the blocking unit 17 in a release position, wherein the blocking elements 19 are parallel to the longitudinal axis X and thus substantially parallel to the air flow L. The air flow L can therefore be discharged after passing through the exchanger arrangement 9 on the outlet side A without greater resistance through the air passage arrangement 16 (as also shown in FIG. 8). As can be seen in FIG. 5, the top and bottom blocking element 19 fulfils a double function with respect to the vertical axis Z. In the release position, the said blocking elements 19 block a connection between the respective return channel 22 and the outlet region 21. This prevents a portion of the air flow L through one of the return channels 22 to bypass the exchange arrangement 9.

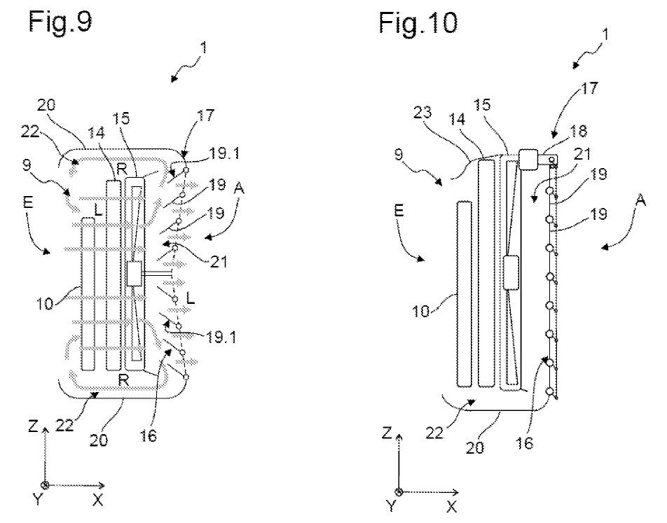

FIG. 6 shows the blocking unit in a central position, wherein the blocking elements 19° are aligned at an angle of about 45 to the longitudinal axis X. In this case, part of the air flow L can still pass between the blocking elements 19 and pass to the outlet side A through the air passage arrangement 16. Another part is stopped by the blocking elements 19 and guided by their oblique surfaces 19.1 to the respective nearest return channel 22. The corresponding air flows L, R are shown in FIG. 9, which refers to the almost identical second embodiment.

FIGS. 7 to 9 show a second embodiment, which differs from the first embodiment essentially in that: That the blocking elements 19 also have in the blocking position shown in FIG. 7 obliquely to the longitudinal axis X aligned surfaces, through which a part of the air flow L is deflected to the respective nearest return channel 22. For reasons of clarity, actuator 18 was omitted in this case. FIG. 8 shows the blocking unit 17 in the locked position and FIG. 9 shows the blocking unit 17 in a central position. Although only one center position is shown in each case, in this as well as in other embodiments any center positions can be assumed, which lie in each case between the locked position and the release position.

FIG. 10 shows a third embodiment similar to the first and second embodiments. However, in this case, a return channel 22 is provided only with respect to the vertical axis Z below the exchanger arrangement 9. Above, a barrier wall 23 is directly connected to the exchanger arrangement 9, i.e. there is no feedback channel formed and there can also be no return current R formed here. Accordingly, this embodiment takes up less installation space upwards, which can be advantageous depending on the design of the electric vehicle 50.

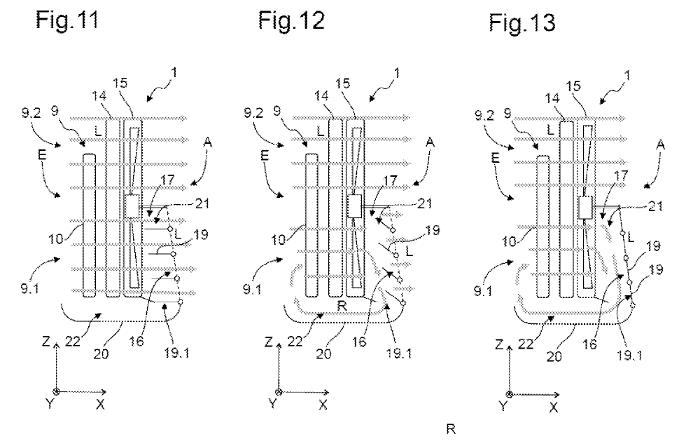

FIGS. 11 to 13 show a fourth embodiment similar to the first and second embodiments. However, the air passage arrangement 16 with the blocking unit 17 with respect to the vertical axis Z is only arranged at the height of a lower part portion 9.1 of the exchanger arrangement 9 and it does not extend to the height of an upper part portion 9.2. Therefore, the air flow L can pass through the upper part of the primary heat exchanger section 11 and continue to flow to the outlet side A without resistance, both in the presence of the release position according to FIG. 9.2 and in the presence of the center position according to FIG. 12 or the blocking position according to FIG. 13. Starting from the lower part region 9.1, on the other hand, the air flow L can be deflected wholly or partially to the return channel 22 formed below the exchanger arrangement 9, depending on the position of the blocking unit 17.

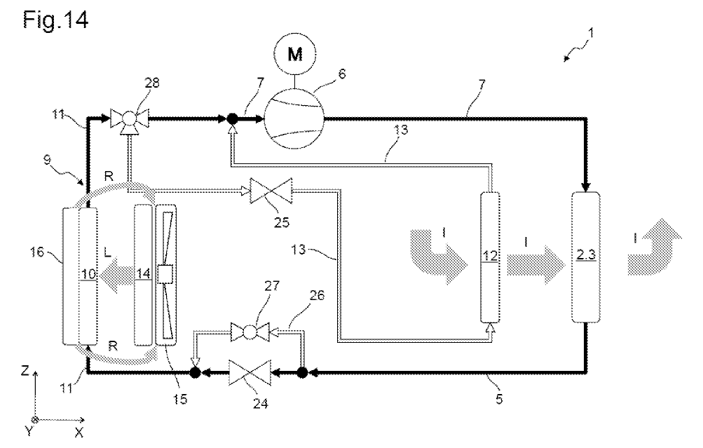

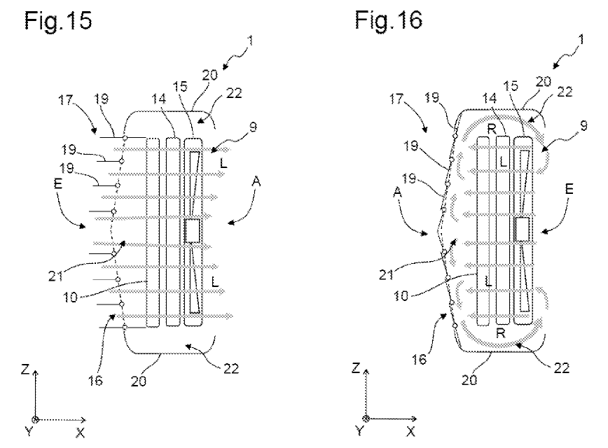

FIGS. 14 to 16 show a fifth embodiment of a temperature control system 1 according to another embodiment, which in turn resembles the first embodiment and is not discussed again in this respect. However, in this case, the air passage arrangement 16 is arranged with respect to the longitudinal axis X in front of the primary heat exchanger 10. FIG. 15 shows the blocking unit 17 in the release position, wherein the air flow L from the in the direction of the longitudinal axis X runs. Accordingly, in this case, the entry side E is arranged in front of the exchange arrangement 9 and the exit side A is behind. FIG. 15 corresponds to a situation with a comparatively high outside temperature, in which no air circulation is necessary. The air flow L can be generated in whole or in part by the driving movement of the electric vehicle 50. FIG. 16 shows the blocking unit in the locked position, wherein the air flow L runs opposite to the longitudinal axis X. Accordingly, the outlet side A is arranged in front of the exchanger arrangement and the inlet side E is behind. The fan unit 15 operates in the reverse direction as when the enable position is present. In this case, the air flow L takes up heat when passing through the radiator 14, which it can then transfer directly to the primary heat exchanger 10. An influx of cold ambient air alignment of the outlet side A is prevented by the closed blocking unit 17. The air flow is in turn diverted to the return channels 22 located above and maintaining the exchange arrangement 9 and passes through them to the inlet side E.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A temperature control system for a vehicle, comprising:
an exchanger assembly including a radiator configured to dissipate operating heat, and a primary heat exchanger positioned forward of the radiator with respect to a longitudinal axis of a vehicle;
a fan unit configured to generate an air flow through the exchanger assembly from an inlet side to an outlet side;
an air passage arrangement disposed on the outlet side of the exchanger assembly;
a blocking unit associated with the air passage arrangement and movable between a release position and a blocking position to selectively restrict air flow through the air passage arrangement; and
at least one guide wall spaced transversely from the exchanger assembly and defining, together with the exchanger assembly, a return channel configured to guide at least a portion of the air flow from the outlet side back toward the inlet side.

2. The temperature control system of claim 1, further comprising:
a compressor configured to circulate a working fluid; and
a temperature control device configured for heat exchange between the working fluid and at least one vehicle region, wherein the primary heat exchanger is fluidly coupled to the temperature control device via a first expansion valve upstream of the primary heat exchanger and fluidly coupled to the temperature control device via the compressor downstream of the primary heat exchanger.

3. The temperature control system of claim 1, wherein return channels are formed on opposite sides of the exchanger assembly with respect to a transverse axis, each return channel being bounded by at least one guide wall.

4. The temperature control system of claim 1, further comprising a barrier wall directly connected to the exchanger assembly on one transverse side thereof to prevent return air flow on that side.

5. The temperature control system of claim 1, wherein the blocking unit is positioned at a height corresponding to a first partial region of the exchanger assembly, and a second partial region of the exchanger assembly is offset relative to the blocking unit such that air may pass through the second partial region independently of the blocking unit.

6. The temperature control system of claim 1, wherein the blocking unit includes at least one blocking element configured, in the release position, to inhibit fluid communication between the return channel and an outlet region between the exchanger assembly and the air passage arrangement, and configured, in the blocking position, to permit fluid communication therebetween.

7. The temperature control system of claim 1, wherein the air passage arrangement is positioned rearward of the exchanger assembly with respect to the longitudinal axis, and wherein the air passage arrangement and/or the guide wall is disposed between the exchanger assembly and an engine compartment of the vehicle.

8. The temperature control system of claim 1, wherein the air passage arrangement is positioned forward of the exchanger assembly with respect to the longitudinal axis.

9. The temperature control system of claim 1, wherein the blocking unit is motorized and is adjustable to at least one intermediate position between the release position and the blocking position to partially restrict air flow.

10. The temperature control system of claim 1, wherein at least one blocking element includes an obliquely oriented surface configured to deflect a portion of the air flow toward the return channel when the blocking unit is in the blocking position or an intermediate position.

11. The temperature control system of claim 1, wherein the fan unit is configured to operate in opposite rotational directions to selectively reverse a direction of the air flow through the exchanger assembly.

12. The temperature control system of claim 1, wherein the radiator is part of a cooling circuit for an electric drive motor or transmission of an electric vehicle.

13. The temperature control system of claim 2, wherein the temperature control device includes an interior heat exchanger configured to condition air within a passenger compartment of an electric vehicle.

14. The temperature control system of claim 2, wherein the temperature control device includes a battery heat exchanger configured to control a temperature of a traction battery of an electric vehicle.

15. The temperature control system of claim 1, wherein the blocking unit includes a plurality of pivotable lamellae arranged in parallel.

16. The temperature control system of claim 1, wherein the guide wall is connected to the air passage arrangement.

17. The temperature control system of claim 1, wherein the return channel extends along at least a majority of a height of the exchanger assembly.

18. The temperature control system of claim 1, wherein, in the blocking position, the air flow forms a circulating flow path through the radiator, the return channel, and the primary heat exchanger.

19. The temperature control system of claim 1, wherein the air passage arrangement includes a grille configured to selectively admit or block ambient air from outside the vehicle.
